(19) United States
(12) Patent Application Publication
(10) Pub. No.: US 2012/0244336 A1
(43) Pub. Date: Sep. 27, 2012

(54) SPUN-DYED HMLS MONOFILAMENTS, PRODUCTION THEREOF AND USE THEREOF

(75) Inventors: Kurt-Günther Berndt, Graben (DE); Rex Delker, Wehringen (DE); Reinhardt Schenzinger, Dinkelscherben-Fleinhausen (DE); Andreas Dirr, Egmating (DE)

(73) Assignee: Nextrusion GMBH, Bobingen (DE)

(21) Appl. No.: 13/504,273

(22) PCT Filed: Oct. 21, 2010
(86) PCT No.: PCT/EP10/06442

§ 371 Date: May 24, 2012

(30) Foreign Application Priority Data
Nov. 12, 2009 (DE) DE10 2009052935.7
Oct. 21, 2010 (EP) PCT/EP2010/006442

(51) Int. Cl. C08L 67/03; B32B 5/02; C08L 85/02; B29C 47/30; C08K 5/17; C08K 11/00

(52) U.S. Cl. 428/221; 524/605; 524/210; 524/80; 524/603; 264/13

(57) ABSTRACT

A spun-dyed polyester monofilament is provided having a linear density of at least 40 dtex containing at least one pigment selected from the group of phthalocyanine, metallophthalocyanine, pyrazolone, anthraquinone, dioxazine, sulfur, azo, dibenzanthrone and/or perylene pigments, wherein the sum total of free hot-air shrinkage after 30 minutes' treatment at 180° C. and extension at a specified load of 27 cN/tex from the stress-strain diagram of the polyester monofilament is less than 15%.

### CLAIM FOR PRIORITY

This patent application is based on PCT Application Serial No. PCT/EP2010/006442, filed Oct. 21, 2010 which claims priority to German Patent Application Serial No. DE 10 2009 052 935.7, filed Nov. 12, 2009. The priorities of the foregoing patent applications are hereby claimed and their disclosures incorporated herein by reference.

### BACKGROUND

The present invention relates to spun-dyed HMLS monofilaments, their production and use in the building construction sector. These monofilaments are preferably useful in the building construction sector in the form of textiles, for example for lightweight roof structures for shading or façade claddings.

Industrial applications have a preference for synthetic threads formed from melt-spinnable polymers. Long-known standard polymers, for example polyolefins, such as polyethylene (PE), polypropylene (PP), polyamides, such as nylon-6 (PA 6), nylon-6,6 (PA 66) or polyester, such as polyethylene terephthalate (PET), are used for cost reasons provided threads formed from these polymers are able to meet the desired requirements.

Dimensional stability is often desired in technical textiles. A textile thread's dimensional stability increases as its mechanical extensibility and its shrinkage on exposure to heat decreases.

The stress-strain curve of a textile thread is enlisted as one way to assess these physical quantities. The curve rises more or less steeply depending on the raw material used. The start of the curve is usually reversible. This is where Hook's law that extension is proportional to the force applied is approximately valid.

At higher extensions, the stress-strain diagram is no longer linear. Extension is then generally no longer reversible. As force and extension increase, the curve builds to a maximum at which the yarn breaks.

With most industrial applications it is desired to remain in the linear portion of the stress-strain curve. The greater the steepness of this curve, the higher the modulus of elasticity. The modulus of elasticity is defined as the slope of the tangent to the stress-strain curve at the point of origin, i.e., at 0% strain. In practice, it is usually the secant which intersects the stress-strain curve at 0% and 1% strain which is usually used, or else the secant at 0.5% and 1.0% strain; usually, there is scarcely any difference between the slopes of these two secants and the tangent to the curve at 0% strain.

Practical engineers try to provide threads which in service remain in the linear portion of the stress-strain curve. One solution is to make thread linear density so high that the forces which arise do not cause exceedance of the linear portion of the stress-strain diagram. A further solution is to provide threads having high moduli of elasticity. A high modulus is achieved, for example, via extremely high draw ratios for the synthetic threads, since the molecular chains will become very substantially oriented in the process. As a result, there is only little residual extensibility left before thread breakage.

Hot-air shrinkage is a further measure of the dimensional stability of synthetic threads. Molecular chain mobility increases at high temperatures. The higher the degree of orientation of the chains, the higher therefore the shrinkage of the thread.

High orientation (draw ratio) does provide a high modulus, but generally only at the expense of high hot-air shrinkage, and vice versa.

The sum total of elongation and shrinkage is therefore the preferred measure of dimensional stability. Breaking extension is less suitable for this, since it is subject to certain fluctuations. Preference is given to using what is known as elongation at specific load (EASL).

The position of shrinkage is similar. It is preferably the free shrinkage which is reported, i.e., the shrinkage without pre-tensioning the thread, on treating the thread at a fixed temperature, for example at 180° C., for a defined treatment period of 30 min for example. Shrinkage does of course also depend on the polymer used.

For a normal polyester thread of PET, for example, EASL at 27 cN/tex and the free hot-air shrinkage (HAS) at 180° C. can be used. Typical values for “slow”-spun and subsequently drawn PET threads are

EASL+HAS=25%.

The sum total of the two quantities does remain approximately constant on varying one parameter. This sum total of elongation at specific load and hot-air shrinkage is thus very useful as measure of dimensional stability.

High modulus low shrinkage (HMLS) threads are desirable for industrial yarns.

A person skilled in the art knows that a high jet stretch ratio, i.e., a high ratio between the takeoff speed and the extrusion speed in the spinning process, will result in substantial orientation of the molecular chains in the longitudinal direction. A subsequent drawing operation serves to further orient and crystallize the molecular chains. This provides high moduli and also low shrinkage values owing to the partly crystalline fraction.

HMLS monofilaments, HMLS multifilaments and cords produced therefrom are already known. Such threads and their production are described for example in DE 196 53 451 A1, DE 199 37 728 A1, DE 691 26 914 T2, DE 699 26 056 T2, EP 1 571 243 A1, WO 2004/046434 A1 and DE 691 08 785 T2. HMLS multifilaments were mainly used as tire cord in the past. HMLS monofilaments have also already been proposed for this use.

Jet stretch ratio and crystallization are influenced by polymer viscosity, the type of polymer, crosslinking agent, further possible admixtures and the cooling process beneath the spinneret die, as elaborated in numerous documents.

When dimensional stability is expressed as the sum total of EASL+HAS, values of 6% to 8% are attainable here for PET, which are used for tire cord for example.

To achieve high jet stretch ratios, takeoff speeds of >2000 m/min are typical. Industrial multifilament yarns generally have filament linear densities of 5-8 dtex. Nor do these takeoff speeds present any problems given that multifilament yarns are typically air quenched downstream of the spinneret die.

The situation is different with monofilaments. Owing to the comparatively high linear density of these individual filaments—for example between 40 dtex and 1000 dtex corresponding to a diameter range from about 64 μm to 300 μm—adequate air quenching is no longer possible, since the heat cannot be transported away sufficiently fast. Therefore, a spin tank of water is generally used as quenching medium. As a result of the associated friction takeoff speeds above 2000 m/min are not possible. Depending on monofilament linear density/diameter, takeoff speed should not exceed 250 to 300 m/min.

Monofilaments intended for use in the building construction sector should be flame retardant and also contain certain admixtures, such as dyes and preferably also stabilizers.

A person skilled in the art would expect admixtures to have an adverse effect on HMLS properties. Admixtures are generally masterbatched into the base polymer prior to spinning. Owing to greater ease of incorporation and distribution in the base polyester, masterbatches are frequently based on polymers that are softer than the base polyester, for example on polybutylene terephthalate (“PBT”) or on copolymers. The use of these polyesters thus leads to a deterioration in dimensional stabilities compared with monofilaments constructed of the base polyester only.

The present invention has for an object of the invention to provide HMLS monofilaments useful in the building construction sector and having good HMLS properties.

The present invention further has for another object of the invention to provide a simple process for producing spun-dyed HMLS monofilaments.

### SUMMARY OF INVENTION

The present invention provides a spun-dyed polyester monofilament having a linear density of at least 40 dtex containing at least one pigment selected from the group of phthalocyanine, metallophthalocyanine, pyrazolone, anthraquinone, dioxazine, sulfur, azo, dibenzanthrone and/or perylene pigments, wherein the sum total of free hot-air shrinkage after 30 minutes' treatment at 180° C. and extension at a specified load of 27 cN/tex from the stress-strain diagram of the polyester monofilament is less than 15%.

### DETAILED DESCRIPTION

The invention is described in detail below with reference to several embodiments and numerous examples. Such discussion is for purposes of illustration only. Modifications to examples within the spirit and scope of the present invention, set forth in the appended claims, will be readily apparent to one of skill in the art.

Any fiber-forming polyester can be used for the monofilaments of the present invention provided it can be processed into HMLS monofilaments having the above-described profile of properties.

Monofilaments of aromatic-aliphatic polyester homo- or copolymers are typically concerned. Examples thereof are polyethylene terephthalate homopolymers or copolymers containing ethylene terephthalate units. These preferred polymers thus derive from ethylene glycol and optionally further alcohols as well as from terephthalic acid or its polyester-forming derivatives, such as esters or chlorides of terephthalic acid.

In addition to or instead of ethylene glycol, these polyesters may contain structural units derived from other suitable dihydric alcohols. Typical representatives thereof are aliphatic and/or cycloaliphatic diols, for example propanediol, 1,4-butanediol, cyclohexanedimethanol or mixtures thereof.

In addition to or instead of terephthalic acid or its polyester-forming derivatives, these polyesters may contain structural units derived from other suitable dicarboxylic acids or from their polyester-forming derivatives. Typical representatives thereof are aromatic and/or aliphatic and/or cycloaliphatic dicarboxylic acids, for example naphthalenedicarboxylic acid, isophthalic acid, cyclohexanedicarboxylic acid, adipic acid, sebacic acid or mixtures thereof.

Monofilaments are also obtainable from other polyesters, such as polybutylene terephthalate, polypropylene terephthalate, polyethylene naphthalate homopolymer or copolymers containing ethylene naphthalate units.

These thermoplastic polyesters are known per se. Building blocks of thermoplastic copolyesters are preferably the abovementioned diols and dicarboxylic acids, or correspondingly constructed polyester-forming derivatives.

The monofilaments of the present invention preferably derive from polyesters whose intrinsic viscosities (IV values) are at least 0.60 dl/g, preferably in the range from 0.80 to 1.05 dl/g and more preferably 0.80-0.95 dl/g (measured at 25° C. in dichloroacetic acid (DCE)).

The monofilaments of the present invention are spun-dyed. A colored monofilament, the preference is for black, is desirable for shading in particular. The abovementioned pigments can be used. They are mainly colored bodies which are not soluble in the base polymer and form a finely dispersed heterogeneous phase in the base polymer.

Pigments suitable for producing the monofilaments of the present invention are known to a person skilled in the art.

Especially the IR content of direct insolation becomes absorbed in the monofilament, and the latter can heat up to temperatures above the glass transition point. Hence the structure becomes “soft” and can deform.

To counteract this, it is a perylene pigment which is preferably used according to the invention. This perylene pigment is used with particular preference in the form of a black masterbatch containing a perylene pigment; the product Lifocolor black VP 132-08 TPE from Lifocolor Farben GmbH & Co KG, Lichtenfels, is especially suitable for this. Perylene is heat-resistant and absorbs less IR radiation than, for example, an otherwise customary carbon black as dye.

Any desired compound comprising a perylene core structure can be used as perylene pigment provided on incorporation in a matrix containing thermoplastic polyesters it provides a coloration of the polyester.

Particularly suitable classes of perylene pigments are perylene itself, i.e., peri-dinaphthylene, the perylene derivatives. Examples of perylene derivatives are tetracarboxylic acids of perylene, their derivatives, such as dianhydrides, diimides including the bis-N-hydrocarbyldiimides such as the bis-N-alkyldiimides, tetracarboxylic esters or tetracarboxamides; di-, tri- or tetraalkyl derivatives of perylene, di- or tetraketones of perylene, di-, tri- or tetrahydroxy derivatives of perylene, di-, tri- or tetraethers of perylene.

Particular preference is given to using perylene, 3,4,9,10-perylenetetracarboxylic acids, 3,4,9,10-tetracarboxylic dianhydride, 3,4,9,10-tetracarboxylic diimide and/or N,N′-dimethyl-3,4,9,10-tetracarboxylic diimide.

The pigment type selected for use in the individual case depends on its compatibility with the polyester matrix and the particular desired hue desired for the monofilament. The selection criteria for this are known to a person skilled in the art.

The pigment in the monofilament of the present invention can be used alone or in the form of mixtures optionally in combination with further pigments. The pigments can be used for example in the form of dry pigments, liquid pigments, encapsulated pigments, pigment dispersions or most preferably in the form of a masterbatch with a carrier polymers, for example a polyolefin, a thermoplastic polyester or a thermoplastic elastomeric polymer.

Introducing the pigment into the thermoplastic polyester can be effected by following various processes described in the prior art. These include, for example, mixing the pigment with the polyester or dissolving and/or dispersing the pigment in the polyester.

In one preferred embodiment, the monofilament of the present invention, in addition to the thermoplastic polyester and the pigment, contains by way of a further component a polymer having a melting point in the region of or below the melting point of the thermoplastic polyester, preferably not less than 10° C. below the melting point of the thermoplastic polyester.

Selected polymers are used as further polymeric component. What is typically concerned here is the polymeric component of a masterbatch used to produce the monofilaments of the present invention. To ensure adequate formability and miscibility in the extruder, the melting point of the further polymer should be in the region of the melting point or preferably at least 10° C. below the melting point of the polyester of the base component.

Examples of suitable further polymers are polyesters, polyamides, polyolefins, such as polyethylene or polypropylene, or thermoplastic elastomeric polymers. It is very particularly preferable for a masterbatch to contain the same type of polymer as the base polymer.

The pigments are in a state of dispersion in the masterbatch used according to the present invention. The masterbatch is incorporated in the polyester matrix in the course of producing the monofilament. The pigment molecules color the monofilament. It transpires that, surprisingly, the pigment colors the monofilament while absorbing thermal radiation to a limited extent only and reflecting the main part of the incident radiation, so that the monofilament heats up less as a result of insolation than would be the case if colored using carbon black.

In a further preferred variant, the monofilaments of the present invention are flame retardant. In this variant, flame retardancy is a further important property of the monofilament according to the present invention. Flame-retardant monofilaments are used in the building construction sector for reasons of fire protection. Incombustible or flame-retardant materials are thus used for textile architecture.

Fire protection in these preferred monofilaments of the present invention can be achieved when using flame retardants known per se. Alternatively or additionally, the polyester raw material used for producing the monofilament of the present invention can also be flame retardant. A wide variety of raw materials have proved useful here as flame-retardant PET raw material; for example the raw material types RT 16, RT 18 and RT 1802 from Trevira GmbH, Philipp-Reis-Straβe 2, 65795 Hattersheim.

These flame-retardant polyester raw materials contain phosphorus-containing structural units in the polymer scaffolding and have been commercially known for years.

Using these raw materials achieves virtually the same physical textile properties as described above for “pure” PET.

Preference is given to monofilaments containing flame-retardant additives, especially in the form of phosphorus-containing and/or halogen-containing compounds.

Particular preference is given to monofilaments constructed of phosphorus-containing polyester and very particular preference to polyethylene terephthalate modified with phosphorus-containing monomers.

In a further preferred variant, the monofilaments of the present invention comprise a friction-reducing additive. Particular preference is given to using friction-reducing additives which in addition to fatty acid amide or mixtures of various fatty acid amides further contain phosphites and mineral powders, preferably calcium carbonate. Phosphites act as costabilizers and mineral powders act as nucleating agents. It is particularly preferable for such friction-reducing additives to be incorporated in the monofilament in the form of a masterbatch. Useful carriers are particularly polyolefins, such as polyethylene or polypropylene, or polyesters, such as polyethylene terephthalate or such as polybutylene terephthalate. Useful fatty acid amides include particularly amides of saturated or unsaturated carboxylic acids having six to twenty carbon atoms. Preference is given to using oleamide, especially in combination with other fatty acid amides.

The monofilaments additized with additives that are friction reducing and contain fatty acid amides exhibit a distinctly enhanced soil repellency as well as a distinctly reduced stick and slip friction. Without wishing to be tied down to any one theory, it is believed that fatty acid amide, especially oleamide, is continually able to migrate out of the polyester matrix of the monofilament, since its surface energy is greater than that of polyester. The result is a permanent lowering in the wettability of the polyester surface, leading to reduced vulnerability to soiling by liquids.

The monofilaments of the present invention, in addition to the polyester base material and the pigment, optionally further polymers, optionally flame retardants and optionally friction-reducing additives, may contain still further admixtures.

Examples of further admixtures are UV stabilizers, hydrolysis stabilizers, processing aids, antioxidants, plasticizers, further slip agents, further pigments, viscosity modifiers or crystallization accelerants.

Examples of UV stabilizers are UV-absorbing compounds, such as benzophenones or benzotriazoles, or HALS hindered amine light stabilizer type compounds.

Examples of hydrolysis stabilizers are carbodiimides or epoxidized compounds.

Examples of processing aids are siloxanes, waxes or comparatively long-chain carboxylic acids or their salts, aliphatic, aromatic esters or ethers.

Examples of antioxidants are phosphorus compounds, such as phosphoric esters, or sterically hindered phenols.

Dioctyl phthalate is an example of a plasticizer.

Polyolefin waxes are examples of further slip agents.

Examples of further pigments or delusterants are inorganic pigments, such as titanium dioxide, or carbon black/graphite.

Examples of viscosity modifiers are polybasic carboxylic acids and their esters or polyhydric alcohols.

It is particularly preferable for the monofilament of the present invention to contain at least one UV stabilizer.

The linear density of monofilaments according to the present invention is at least 40 dtex, but can otherwise vary within wide limits. Typical linear densities range from 40 to 300 dtex and especially from 45 to 200 dtex.

The cross-sectional shape of the threads of the present invention is freely choosable. Irregular cross sections, point- or axially symmetrical cross sections may be concerned, for example round, oval or n-angular cross sections, where n is not less than 3.

The amounts of base polymer, pigment, further polymer and further admixtures in the monofilaments of the present invention can be chosen within wide limits.

Typically, the monofilament according to the present invention contains from 70 to 99.999 wt % and preferably from 95 to 99.98 wt % of base polymer, based on total monofilament mass. The amount of base polymer is selected by a person skilled in the art as a function of the desired purpose of use and/or the intended processing.

The amount of pigment in the monofilament of the present invention is likewise selected by a person skilled in the art as a function of the desired purpose of use and/or the intended processing.

The amount of pigment in the monofilament of the present invention is typically in the range from 0.0001 to 5 wt %, based on total monofilament mass, and preferably in the range from 0.001 to 3 wt %.

The amount of optional flame retardant in the monofilament of the present invention is likewise selected by a person skilled in the art as a function of the desired purpose of use and/or the intended processing.

The amount of flame retardant in the monofilament of the present invention is typically in the range from 0 to 15 wt %, based on total monofilament mass, preferably in the range from 0.1 to 10 wt % and especially in the range from 1 to 5 wt %.

The amount of optional further polymer in the monofilament of the present invention is likewise selected by a person skilled in the art as a function of the desired purpose of use and/or the intended processing.

The amount of this component is typically in the range from 0 to 25 wt %, based on total monofilament mass.

The portion of the further admixtures optionally used is likewise selected by a person skilled in the art according to the intended purpose of use and/or the intended processing. The proportion of this component is typically up to 20 wt % and preferably up to 10 wt %, based on total monofilament mass.

When UV stabilizers are added, the amount thereof in the monofilament of the present invention is typically in the range from 0.0001 to 5 wt %, based on total monofilament mass, and preferably in the range from 0.001 to 2 wt %.

The components needed to produce the monofilaments of the present invention are known per se, commercially available in some instances or obtainable by methods known per se.

The threads of the present invention are preferably used for producing textile fabrics, especially wovens, laids, formed-loop knits, braids or drawn-loop knits. These fabrics are produced using known techniques.

The monofilaments of the present invention are obtainable via a modification of the conventional melt-spinning process, combined with single or multiple drawing and setting of the monofilaments obtained.

The invention also provides a process for the polyester monofilaments described above. A polyester raw material is metered into an extruder together with the dye, preferably in the form of a masterbatch. The finely drilled hole in the spinneret die has a larger cross-sectional area than in the case of spinneret dies typically used for monofilaments of these diameters.

This measure lowers the extrusion speed of the polymer for a given throughput. A takeoff speed of 300 m/min, which is still implementable with spin tanks of water, provides a jet stretch ratio as required for producing HMLS threads.

The diameter of the finely drilled holes in the spinneret die is typically in the range from 0.4 to 1.0 mm and preferably in the range from 0.4 to 0.8 mm in the process of the present invention. Finely drilled hole refers to the drilled hole at the exit-side end of the polymer mass.

The operation integrates one or more draws with thermal effects to endow the thread with its final properties.

The thread obtained is preferably drawn multiple times, especially in a total draw ratio ranging from 5.0:1 to 6.5:1.

It is particularly preferable for the drawing stages to be followed by at least one relaxation stage (setting stage). In it, the drawn monofilaments are thermally treated while thread tension is retained to decrease stresses that have built up in the thread.

The monofilaments produced are subsequently converted into a suitable form for storage by winding up for example.

The invention also provides a process for producing the above-described spun-dyed HMLS monofilaments comprising the measures of
i) mixing thermoplastic polyester with a masterbatch containing a fiber-forming polymer and at least one pigment selected from the group of phthalocyanine, metallophthalocyanine, pyrazolone, anthraquinone, dioxazine, sulfur, azo, dibenzanthrone and/or perylene pigments in an extruder,
ii) extruding the mixture from step i) through a spinneret die having one or more finely drilled holes having a diameter of 0.4 to 1.0 mm,
iii) taking the produced filament off at a takeoff speed of not less than 300 m/min and preferably in the range from 200 to 300 m/min,
iv) drawing the produced monofilament one or more times,
v) relaxing the produced monofilament, and
vi) optionally winding the produced monofilament up.

The abovementioned procedure typically provides EASL_{27cN/tex}+HAS_{180° C./30 min} values of less than 15% for the dimensional stability of the monofilaments. Preference is given to values of less than 12% and especially values between 9.5% to 10.1%.

These values are not quite as advantageous as with multifilaments, but these monofilaments can nonetheless still be regarded as HMLS monofilaments that meet the stipulated requirements in textile architecture for example.

Surprisingly, the properties of the monofilaments produced meet the performance profile required of HMLS threads even on addition of masterbatches containing softer polymers than the base polymer, such as PBT or PTE-E.

The monofilaments of the present invention are very useful in building construction, especially in textile architecture and most preferably for lightweight roof structures, shading, façade cladding and also for decorative textile areas in or on buildings.

These uses likewise form part of the subject matter of the present invention.

The present invention is more particularly described by the examples which follow. These examples only serve to illustrate the invention and are not to be construed as limiting it.

### Operative Examples 1 and 2

The starting raw material in both cases was the RT 51 PET from INVISTA Resins & Fibres GmbH in Hattersheim/M. The raw material was solid state condensed to a value of IV=0.823 in a tumble dryer. The polymer stream was gravimetrically admixed upstream of the extruder with 2.4 wt % of Lifocolor black 9000169 TPE masterbatch (from Lifocolor Farben GmbH & Co. KG; Lichtenfels, Germany), compound of a perylene pigment in a thermoplastic copolyester; and also 4.0 wt % of a CESA-F Light NBAADH masterbatch (from Clariant, Frankfurt/M., Germany) as UV stabilizer.

The polymeric mixture was melted in an extruder at 280° C. to 295° C., gear pumped into a spin pack and subsequently spun into a water bath at 50° C. This was followed by multiple hot drawing with heat-setting and also subsequent winding up of the monofilaments.

Table 1 which follows reports operating data and the textile values of the monofilaments obtained.

TABLE 1
Operating Data and Filament Properties

| | Example 1 | Example 2 |
|---|---|---|
| | Monofil | Monofil |
| Diameter (mm) | 0.064 | 0.126 |
| Additive 1 added | Lifocolor black | Lifocolor black |
| | 000169 TPE | 9000169 TPE |
| Additive 2 added | CESA-F Light | CESA-F Light |
| Extruder zones 1-6 (° C.) | 250-295 | 250-295 |
| Spool speed (rpm) | 29 | 45 |
| Extruder pressure (bar) | 100 | 100 |
| Spin pack melt (° C.) | 296 | 298 |
| Spin pack throughput (g/min) | 324 | 552.6 |
| Additive 1 added (%) | 2.4 | 2.4 |
| Additive 1 added (g/min) | 7.8 | 13.3 |
| Additive 2 added (%) | 4.0 | 4.0 |
| Additive 2 added (g/min) | 13.0 | 22.1 |
| Die number of holes | 60 | 40 |
| Die hole diameter (mm) | 0.5 | 0.6 |
| Draw system 1 godet (m/min) | 215 | 143 |
| 1st draw (° C.) | 130 | 130 |
| Draw system 2 godet (m/min) | 1030 | 685 |
| 2nd draw (° C.) | 250 | 250 |
| Draw system 3 godet (m/min) | 1275 | 850 |
| Setting temperature (° C.) | 238 | 240 |
| Draw system 4 godet (m/min) | 1200 | 800 |
| Linear density (dtex) | 45 | 172.7 |
| Tenacity (cN/tex) | 63 | 62 |
| Elongation at break (%) | 18.3 | 19.8 |
| EASL 27 cN/tex (%) | 7.3 | 7.7 |
| Hot-air shrinkage 180° C./30 (%) | 2.2 | 2.4 |
| Dimensional stability EASL + HAS | 9.5 | 10.1 |

The comparison which follows was carried out to explain the low absorption of IR radiation by perylene compared with the carbon black customarily used as dye.

Table 2 which follows shows the heating rates of monofilaments with carbon black and perylene-containing masterbatch. It transpires that the perylene-containing monofilament has a low heating-up rate similar to that of a white monofilament (TiO₂-containing in this instance).

TABLE 2
Comparison of heating rate of monofilaments with different
colored additions

| Time (min) | 0 | 10 | 20 | 30 | 40 |
|---|---|---|---|---|---|
| Carbon black (° C.) | 22 | 60 | 73 | 75 | 80 |
| Black VP 132/08 TPE (° C.) | 22 | 45 | 52 | 54 | 55 |
| TiO₂ white (° C.) | 22 | 42 | 50 | 51 | 51 |

### Operative Example 3

The monofilaments were produced as described in Operative examples 1 and 2. In addition to the masterbatches Lifocolor black 9000169 TPE and CESA-F Light NBAADH between 0 and 10% of a masterbatch based on PBT (Monoslip 230310 PET, U. Müller, Parkstr. 18, Coburg) was metered into the polymer stream. This masterbatch, in addition to the PBT, contained 20 wt % of a mixture of fatty acid amide and oleamide, 0.5 wt % of a phosphitic Co-stabilizer and 15 wt % of calcium carbonate as nucleator.

The monofilaments additized with the components of this masterbatch had significantly reduced coefficients of friction both for stick friction and slip friction compared with monofilaments not additized therewith. As a result, either no spin finish at all was needed to produce the monofilaments, or a significantly reduced spin finish add-on could be used. In addition, the monofilaments additized with this masterbatch displayed distinctly enhanced soil repellency.

Table 3 which follows reports operating data and the textile values of the monofilaments obtained.

TABLE 3
Operating Data and Filament Properties

| | Example 3 Monofil |
|---|---|
| Diameter (mm) | 0.126 |
| Additive 1 added | Lifocolor black 000169 TPE |
| Additive 2 added | CESA-F Light |
| Additive 3 added | Monoslip 230310 PET |
| Extruder zones 1-6 (° C.) | 250-295 |
| Spool speed (rpm) | 45 |
| Extruder pressure (bar) | 100 |
| Spin pack melt (° C.) | 295 |
| Spin pack throughput (g/min) | 553 |
| Additive 1 added (%) | 2.4 |
| Additive 1 added (g/min) | 13.3 |
| Additive 2 added (%) | 4.0 |
| Additive 2 added (g/min) | 22.1 |
| Additive 3 added (%) | 5.0 |
| Additive 3 added (g/min) | 27.7 |
| Die number of holes | 40 |
| Die hole diameter (mm) | 0.6 |
| Draw system 1 godet (m/min) | 14.3 |
| 1st draw (° C.) | 130 |
| Draw system 2 godet (m/min) | 690 |
| 2nd draw (° C.) | 248 |
| Draw system 3 godet (m/min) | 857 |
| Setting temperature (° C.) | 236 |
| Draw system 4 godet (m/min) | 800 |
| Linear density (dtex) | 170.9 |
| Tenacity (cN/tex) | 59 |
| Elongation at break (%) | 20.8 |
| EASL 27 cN/tex (%) | 8.0 |
| Hot-air shrinkage 180° C./30 (%) | 2.4 |
| Dimensional stability EASL + HAS | 10.4 |

While the invention has been described in detail, modifications within the spirit and scope of the invention will be readily apparent to those with skill in the art. In view of the foregoing discussion, relevant knowledge in the art and references discussed above in connection with the Background, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

1-16. (canceled)

17. A spun-dyed polyester monofilament having a linear density of at least 40 dtex containing at least one pigment selected from the group of phthalocyanine, metallophthalocyanine, pyrazolone, anthraquinone, dioxazine, sulfur, azo, dibenzanthrone and/or perylene pigments, wherein the sum total of free hot-air shrinkage after 30 minutes treatment at 180° C. and extension at a specified load of 27 cN/tex from the stress-strain diagram of the polyester monofilament is less than 15%.

18. The polyester monofilament as claimed in claim 17, characterized in that the sum total of free hot-air shrinkage after 30 minutes treatment at 180° C. and extension at a specified load of 27 cN/tex from the stress-strain diagram is less than 12%.

19. The polyester monofilament according to claim 17, characterized in that the linear density of the monofilament is between 45 and 300 dtex.

20. The polyester monofilament as claimed in claim 17, characterized in that the cross section of the monofilament is irregular, point- or axially symmetrical, preferably round, oval or n-angular, where n is not less than 3.

21. The polyester monofilament as claimed in claim 17, characterized in that the monofilament contains at least one UV stabilizer, preferably in an amount of 0.0001 to 5.0 wt %.

22. The polyester monofilament as claimed in claim 17, characterized in that the pigment is a perylene pigment.

23. The polyester monofilament as claimed in claim 17, characterized in that the monofilament is flame retardant.

24. The polyester monofilament as claimed in claim 23, characterized in that the monofilament contains flame-retardant additives.

25. The polyester monofilament as claimed in claim 24, wherein the flame-retardant additives are in the form of phosphorous-containing and/or halogen-containing compounds.

26. The polyester monofilament as claimed in claim 23, characterized in that the monofilament is constructed of phosphorus-containing polyester.

27. The polyester monofilament as claimed in claim 17, characterized in that the monofilament contains polyethylene terephthalate.

28. The polyester monofilament as claimed in claim 17, characterized in that the monofilament contains polyethylene terephthalate modified with phosphorous-containing monomers.

29. The polyester monofilament as claimed in claim 17, characterized in that the monofilament contains a friction-reducing additive.

30. The polyester monofilament as claimed in claim 29, characterized in that the friction-reducing additive contains one or more fatty acid amides.

31. The polyester monofilament as claimed in claim 30, characterized in that the friction-reducing additive additionally contains phosphite and mineral powder.

32. The polyester monofilament as claimed in claim 31, wherein the mineral powder is calcium carbonate.

33. A process for producing spun-dyed polyester monofilaments as claimed in claim 17 comprising the steps of
i) mixing thermoplastic polyester with a masterbatch containing a fiber-forming polymer and at least one pigment selected from the group of phthalocyanine, metallophthalocyanine, pyrazolone, anthraquinone, dioxazine, sulfur, azo, dibenzanthrone and/or perylene pigments in an extruder,
ii) extruding the mixture from step i) through a spinneret die having one or more finely drilled holes having a diameter of 0.4 to 1.0 mm,
iii) drawing the produced monofilament one or more times,
iv) relaxing the produced monofilament, and
v) optionally winding the produced monofilament up.

34. A textile sheet adapted for building construction incorporating the monofilament of claim 17.

35. The textile sheet according to claim 34, wherein the sheet is adapted for roofing structures, shading, façade cladding or textile decoration.
